(19) United States
(12) Patent Application Publication
(10) Pub. No.: US 2026/0284885 A1
(43) Pub. Date: Sep. 24, 2026

(54) COBOT COLLISION RECOVERY SYSTEM

(71) Applicant: NISSAN NORTH AMERICA, INC., Franklin, TN (US)

(72) Inventor: Robert Joseph SCHWARZKOPF, Canton, MS (US)

(21) Appl. No.: 19/085,999

(22) Filed: Mar. 20, 2025

(51) Int. Cl. B25J 9/16; B25J 13/08; B25J 19/06

(52) U.S. Cl. CPC B25J 9/1674; B25J 13/08; B25J 19/063

(57) ABSTRACT

A robotic system is provided. The system includes a robot, a controller, a base, and at least one lock. The controller is configured to control movement of the robot. The robot is mounted on the base, and the base includes a first portion and a second portion. The first portion is in contact with the robot and is rotatable with respect to the second portion. The second portion is fixed. The at least one lock is configured to detachably lock the first portion of the base to prevent rotation with respect to the second portion.

### BACKGROUND

### Field of the Invention

The present invention generally relates to a robotic system. The robotic system includes a robot, a controller, a base and at least one lock. The controller is configured to control movement of the robot. The robot is mounted on the base, and the base includes a first portion and a second portion. The first portion is in contact with the robot and being rotatable with respect to the second portion. The second portion is fixed. The at least one lock is configured to detachably lock the first portion of the base to prevent rotation with respect to the second portion.

The present invention also relates to a method of controlling a robotic system. The method includes providing a movable robot and a base on which the movable robot is mounted. The base includes a first portion and a second portion. The first portion is in contact with the robot and is rotatable with respect to the second portion. The method further includes detachably locking the first portion to the second portion, and releasing the first portion from the second portion such that the first portion can rotate with respect to the second portion when a collision between the movable robot and an object is detected.

### Background Information

Cobots are collaborative robots that are designed to work alongside humans. Cobots are desirable because they can work with humans to perform tasks in an efficient and accurate manner, thereby reducing the workload for the humans. For this reason, cobots are particularly desirable in production assemblies because they can help reduce production time by performing repetitive tasks in an efficient and reliable manner.

When conventional cobots collide with an object, they are designed to go into a protective-stop mode in which they cannot perform regular functions. These conventional cobots can be re-initialized by a human once the object is no longer detected, typically within 15 to 30 seconds of entering the protective-stop mode. Therefore, although the protective-stop mode temporarily interrupts the operation of the cobots, the production time is not significantly increased because re-initialization occurs within a few seconds. However, if these conventional cobots collide with a large immovable object such that the cobot continues to be in contact with the object after entering the protective-stop mode, the cobot cannot be re-initialized and exit the protective-stop mode.

These conventional cobots cannot be re-initialized until they are rotated away from the object with which they have collided. However, when the object is a large immovable object, the object itself cannot be moved. In such a case, the only way to exit the protective-stop mode is to take the cobot apart such that the object is no longer in contact with the cobot. However, a significant amount of time is required to take the cobot apart and re-assemble it so that it can exit the protective-stop mode and re-initialization can occur. This downtime is unacceptable in most production assemblies, where more than one minute of downtime can significantly affect production metrics.

Therefore, further improvement is needed to develop a system in which the cobot can re-initialize quickly even after collision with a large immovable object is detected. In particular, it is desirable to provide a robotic system in which the cobot can quickly be separated from the object with which it has collided, thereby allowing the cobot to exit the protective-stop mode and re-initialize operation.

### SUMMARY

It has been discovered that a cobot can quickly be rotated away from the object with which it has collided by providing a system including a rotating cobot stand that is locked in place by a lock that is actuated by pneumatic cylinders. The lock and pneumatic cylinders are controlled by a controller. By providing a rotating cobot stand that can be actuated in this manner, the system can quickly rotate a cobot mounted on the stand away from an object with which it has collided. Therefore, the system allows the cobot to quickly exit the protective-stop mode even after collision with a large immovable object, allowing for quicker re-initialization and less production downtime than conventional cobot stand systems.

In view of the state of the known technology, one aspect of the present disclosure is to provide a robotic system. The robotic system includes a robot, a controller, a base and at least one lock. The controller is configured to control movement of the robot. The robot is mounted on the base, and the base includes a first portion and a second portion. The first portion is in contact with the robot and being rotatable with respect to the second portion. The second portion is fixed. The at least one lock is configured to detachably lock the first portion of the base to prevent rotation with respect to the second portion.

Another aspect of the present disclosure is to provide a method of controlling a robotic system. The method includes
providing a movable robot and a base on which the movable robot is mounted. The base includes a first portion and a second portion. The first portion is in contact with the movable robot and is rotatable with respect to the second portion. The method further includes detachably locking the first portion to the second portion, and releasing the first portion from the second portion such that the first portion can rotate with respect to the second portion when a collision between the movable robot and an object is detected.

By providing a rotating cobot stand in which the first portion can be detachably locked to the second portion and released when a collision is detected, a cobot mounted on the stand can be quickly rotated away from an object with which it has collided. Therefore, the cobot can quickly recover to normal operation after the collision by quickly exiting the protective-stop mode and re-initializing operation. This allows for minimal downtime and disruption in operation as compared with conventional cobot stand systems.

### BRIEF DESCRIPTION OF THE DRAWINGS

Referring now to the attached drawings which form a part of this original disclosure:

FIG. 1 is a perspective view of a portion of an assembly line including a robotic system according to a first embodiment;

FIG. 2a is a front view of a robotic system in a locked state according to a second embodiment;

FIG. 2b is a side view of the robotic system in the locked state according to the second embodiment;

FIG. 2c is a back view of the robotic system in the locked state according to the second embodiment;

FIG. 2d is a perspective view of the robotic system in the locked state according to the second embodiment;

FIG. 2e is a perspective view of the robotic system in an unlocked state according to the second embodiment;

FIG. 3 is an exploded perspective view of a robotic system according to a third embodiment;

FIG. 4a is a partial perspective view of a robotic system in a locked state according to a fourth embodiment;

FIG. 4b is a partial perspective view of the robotic system in an unlocked state according to the fourth embodiment; and

FIG. 5 is an illustrated flow chart showing a process of controlling a robotic system according to a fifth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

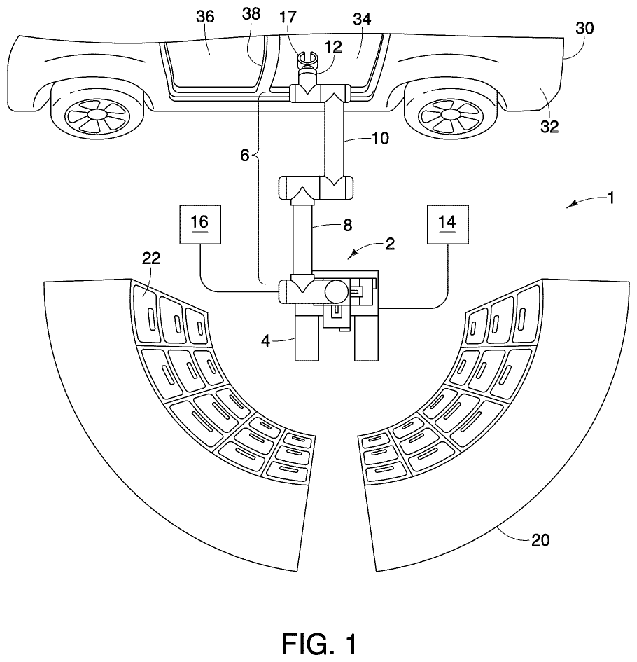

Referring initially to FIG. 1, a portion of an assembly line l including a robotic system 2 is illustrated in accordance with a first embodiment. The portion of the assembly line 1 is part of an assembly line in a car factory. The robotic system 2 is a cobot system in which a robot works alongside human workers. It should be understood that the robotic system 2 can be used in an assembly line of any suitable factory or other production facility.

As shown in FIG. 1, the robotic system 2 includes a base 4 and a robot 6 mounted on the base 4. The base 4 includes a first portion and a second portion. The first portion is an upper portion on which the robot 6 is mounted, and the second portion is a lower portion that is fixed to the ground. The robot 6 can be mounted to the base 4 in any suitable manner. For example, the robot 6 can be mounted to the first portion of the base 4 using at least one mechanical fastener such as a bolt, a nut, and/or a screw. The first portion is rotatable with respect to the second portion.

The base 4 can be formed of any suitable materials. For example, the first portion and the second portion can each be formed of a metal or a plastic material, preferably a metal such as carbon steel. The base 4 has any suitable dimensions. For example, the second portion has a width of approximately 5 to 20 inches, preferably 15 to 20 inches, a depth of approximately 5 to 20 inches, preferably 8 to 10 inches, and a height of approximately 3 to 15 inches, preferably 5 to 10 inches. The first portion has a width of approximately 2 to 10 inches, preferably 5 to 6 inches, a depth of approximately 15 to 20 inches, preferably 5 to 6 inches, and a height of approximately 10 to 40 inches, preferably 15 to 20 inches.

The base 4 also includes at least one lock that is configured to detachably lock the first portion of the base to prevent rotation with respect to the second portion. The lock can be any suitable lock that detachably locks the first portion of the base to prevent rotation with respect to the second portion, and can be released to allow the first portion to rotate with respect to the second portion. The lock is preferably a taper pin, more preferably two taper pins that are actuated by two separate pneumatic cylinders.

As shown in FIG. 1, the robot 6 includes a lower arm 8 and an upper arm 10. It should be understood that the robot 6 can include any suitable number of arms to allow for sufficient movement of the robot 6 for its desired purpose and functionality. The robot 6 also has a short top arm 12 to allow for connection to a tool for picking up objects, such as a grip part. The robot 6 and arms 8, 10 and 12 can have any suitable dimensions. For example, the robot arms 8, 10 and 12 can each have a diameter of approximately 2 to 20 inches, preferably 3 to 5 inches. The robot 6 has an overall height of 5 to 100 inches, preferably 30 to 40 inches.

The robotic system 2 also includes a first controller 14 configured to control the first and second portions of the base 4 as shown in FIG. 1. The first controller 14 is any suitable electronic controller configured to control the base 4 to selectively allow and prevent rotation of the first portion with respect to the second portion. The first controller 14 is preferably a programmable logic controller. The first controller 14 includes one or more processors that execute predetermined control programs to actuate or release the lock to selectively allow rotation of the first portion with respect to the second portion.

In particular, the first controller 14 is configured to control the pneumatic cylinders to hold the taper pins in place using air pressure when the robot 6 is in a state of normal operation. The pneumatic cylinders are configured to hold the taper pins in place by applying air pressure, for example air having a pressure of 80 psi to 110 psi. By controlling the pneumatic cylinders to hold the taper pins in place during normal operation, the first controller 14 prevents rotation of the first portion with respect to the second portion. The first controller 14 is also configured to control the pneumatic cylinders to drop the taper pins by using a solenoid valve to force the taper pins down using air pressure when a collision between the robot 6 and an object is detected, thereby allowing the first portion to rotate with respect to the second portion. The processors of the first controller 14 include, for example, a central processing unit (“CPU”) or a micro-processing unit (“MPU”).

The processors of the first controller 14 can be located at separate positions. For example, some of the processors can be provided in the robotic system 2, and the other processors can be provided in a remote server connected to the internet. In a case where the processors are located at separate positions, the processors are connected to one another via a wireless communication device in a manner allowing for communication. The first controller 14 can include one or more microcomputers. Thus, the term “electronic controller” as used herein refers to hardware that executes a software program, and does not include a human.

The first controller 14 is in communication with the base 4 via wired or wireless communication. For example, the first controller 14 can be located in or within a predetermined distance of the factory where the assembly line is located and can include a communication unit in wired communication with the base 4. The first controller 14 is configured to send commands to the base 4 to control the pneumatic cylinders to actuate or release the lock and thereby allow rotation of the first portion with respect to the second portion.

The robotic system 2 further includes a second controller 16 configured to control movement of the robot 6. The second controller 16 is any suitable electronic controller configured to control the robot 6 to selectively move one or more of the arms 8, 10 and 12. The second controller 16 is preferably a programmable logic controller. The second controller 16 includes one or more processors that execute predetermined control programs to move one or more of the arms 8, 10 and 12 of the robot 6. The processors of the second controller 16 include, for example, a CPU or a MPU.

The processors of the second controller 16 can be located at separate positions. For example, some of the processors can be provided in the robotic system 2, and the other processors can be provided in a remote server connected to the internet. In a case where the processors are located at separate positions, the processors are connected to one another via a wireless communication device in a manner allowing for communication. The second controller 16 can include one or more microcomputers. Thus, the term “electronic controller” as used herein refers to hardware that executes a software program, and does not include a human.

The second controller 16 is in communication with the robot 6 via wired or wireless communication. For example, the second controller 16 can be located in or within a predetermined distance of the factory where the assembly line is located and can include a communication unit in wired communication with the robot 6. The second controller 16 is configured to send commands to the robot 6 to control the movement of the robot 6 to perform desired tasks.

The robot 6 includes a grip part 17 provided at the end of the top short arm 12. The grip part 17 enables the robot 6 to grab, hold, manipulate and/or transport objects. The grip part 17 can be attached to the short arm 12 in any suitable manner, for example using one or more mechanical fasteners, and adhesive, or a combination thereof.

The portion of the assembly line 1 includes a set of boxes 20 that includes a plurality of boxes 22 and a vehicle 30. The boxes 22 each contain at least one manual to be placed in vehicles, such as an owner's manual for the vehicle. The vehicle 30 includes a vehicle body 32, a first passenger area 34 and a second passenger area 36 in the interior of the vehicle, and a divider 38 separating the first and second passenger areas 34 and 36.

The grip part 17 is configured to grab the at least one manual and place the at least one manual in the first passenger area 34 of the vehicle 30. However, when collision with an object is detected, the first controller 14 is configured to release the lock and thereby allow rotation of the first portion with respect to the second portion. In particular, the first controller 14 is configured to control the pneumatic cylinders to actuate or release the taper pins and thereby allow rotation of the first portion with respect to the second portion.

By providing a rotating stand that can be actuated in this manner, the system can quickly rotate a robot mounted on the stand away from an object with which it has collided. Therefore, the system allows the robot to quickly exit the protective-stop mode even after collision with a large immovable object, allowing for quicker re-initialization and less production downtime.

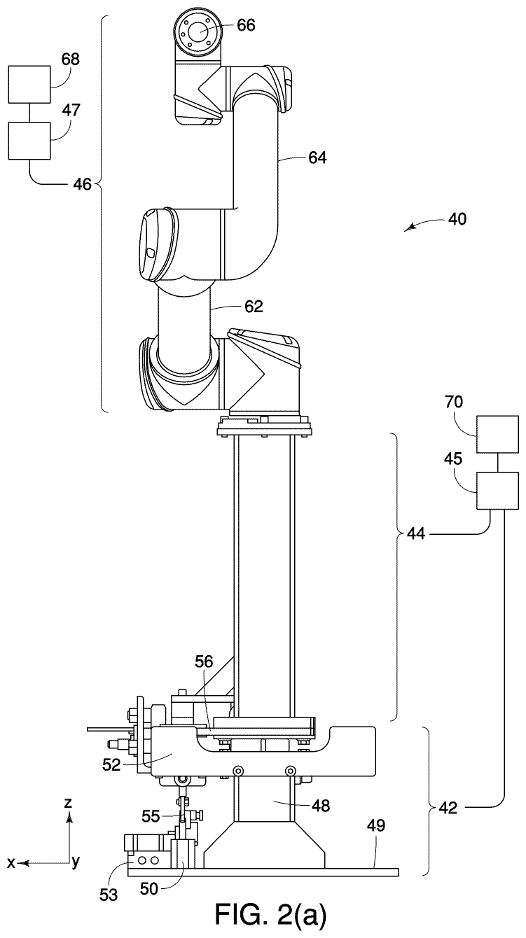

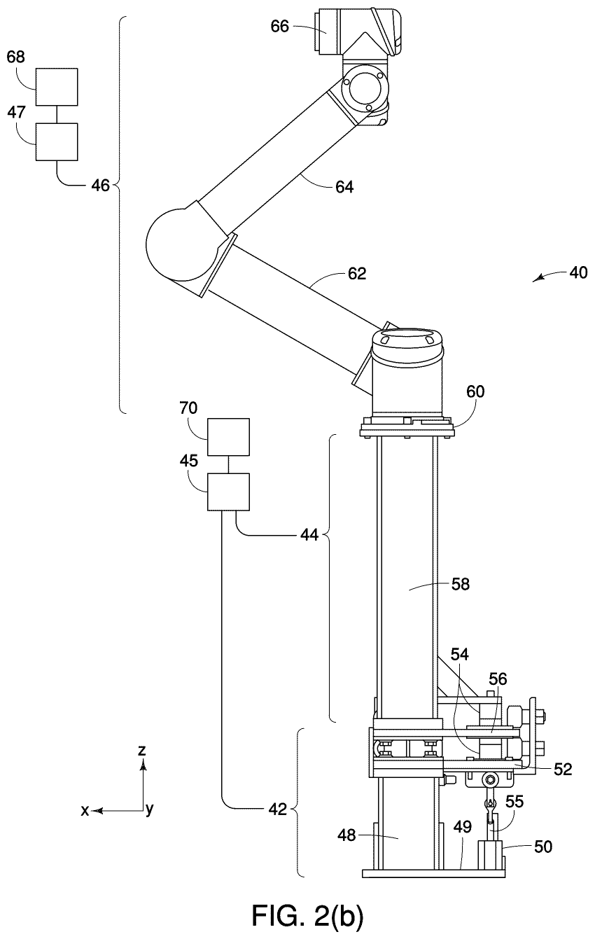

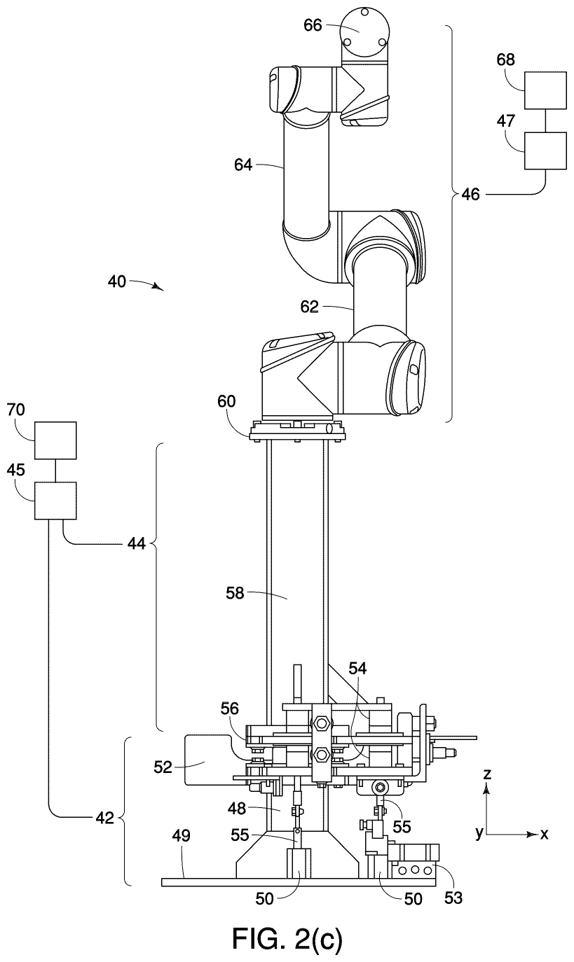

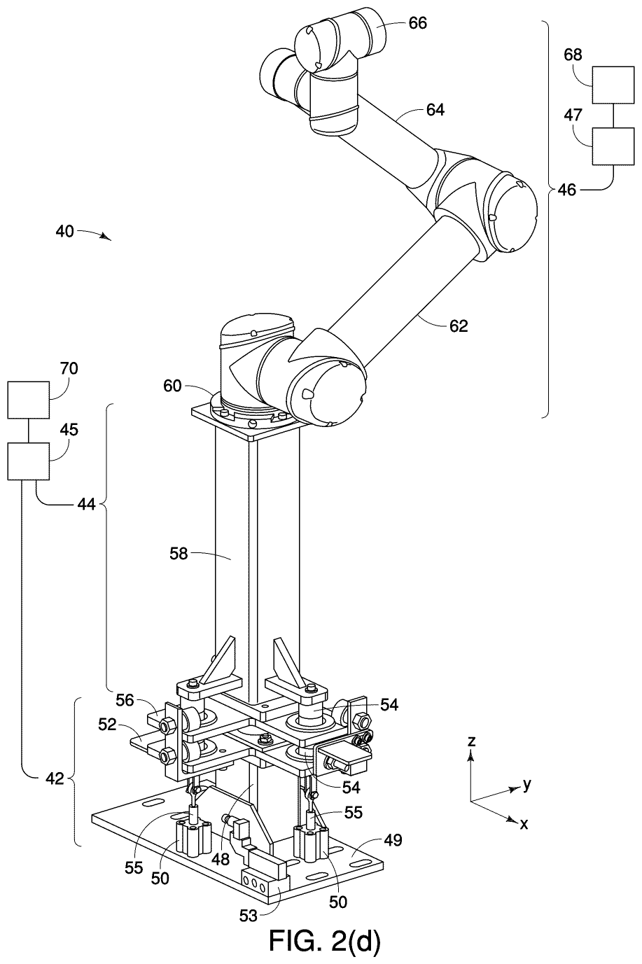

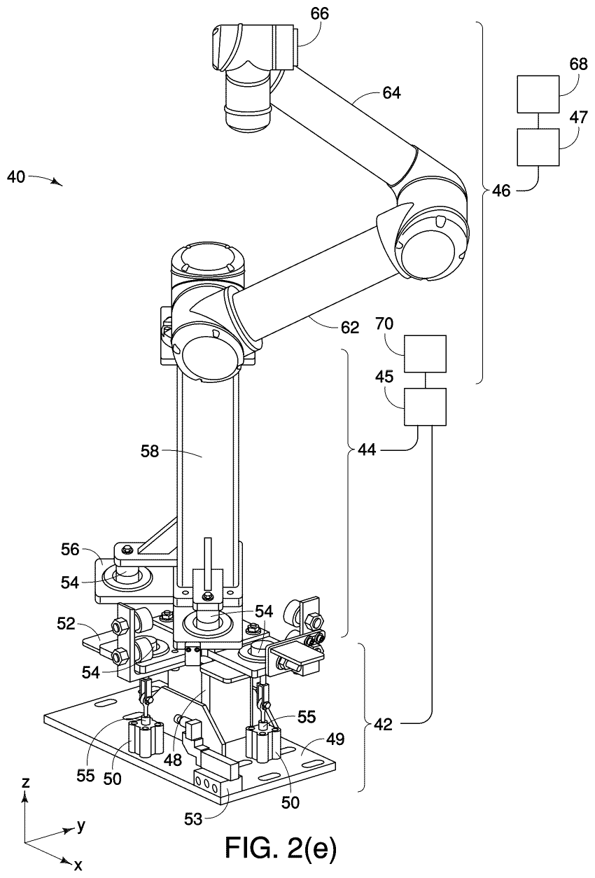

FIGS. 2a-d show various views of a robotic system 40 in a locked state according to a second embodiment. In particular, FIG. 2a shows a front view of the robotic system 40 in the locked state, FIG. 2b shows a side view of the robotic system 40 in the locked state, FIG. 2c shows a back view of the robotic system 40 in the locked state, and FIG. 2d shows a perspective view of the robotic system 40 in the locked state.

As shown in FIG. 2a, the robotic system 40 includes a base formed by a lower portion 42 and an upper portion 44, a first controller 45, a robot 46 mounted on the upper portion 44, and a second controller 47. The robot 46 can be mounted to the upper portion 44 in any suitable manner. For example, the robot 46 can be mounted to the upper portion 44 using at least one mechanical fastener such as a bolt, a nut, and/or a screw. The lower portion 42 is fixed or anchored to the ground or floor in any suitable manner. For example, the lower portion 42 can be fixed to the ground or floor using at least one mechanical fastener, such as a bolt, a nut, and/or a screw, an adhesive, or a combination thereof. The upper portion 44 is rotatable with respect to the lower portion 42 when it is not in the locked state.

As shown in FIGS. 2a-2d, the lower portion 42 includes a lower stand 48, a flat base 49, two pneumatic cylinders 50, and a support assembly 52 for the lower portion. The lower stand 48, the flat base 49, the pneumatic cylinders 50 and the support assembly 52 can be formed of any suitable materials, such as metals or plastic materials, preferably a metal such as carbon steel.

The lower stand 48, flat base 49, pneumatic cylinders 50 and support assembly 52 can have any suitable dimensions. For example, the lower stand 48 has a width of approximately 2 to 10 inches, preferably 5 to 6 inches, a depth of approximately 2 to 10 inches, preferably 5 to 6 inches, and a height of approximately 3 to 15 inches, preferably 5 to 10 inches. The flat base 49 has a width of approximately 5 to 20 inches, preferably 15 to 20 inches, a depth of approximately 5 to 20 inches, preferably 8 to 10 inches, and a height of approximately 0.05 to 3 inches, preferably 0.5 to 1.5 inches. The pneumatic cylinders 50 each have a diameter of approximately 0.1 to 2 inches, preferably 0.5 to 1.5 inches, and a height of approximately 1 to 5 inches, preferably 2 to 3 inches. The support assembly 52 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches.

The robotic system 40 includes a solenoid valve 53 and two pins 54 that are configured to detachably lock the upper portion 44 of the base to prevent rotation with respect to the lower portion 42. The pins 54 include rods 55 and can be any suitable pins that detachably lock the upper portion 44 of the base to prevent rotation with respect to the lower portion 42, and can be released to allow the upper portion 44 to rotate with respect to the lower portion 42. The pins 54 are preferably taper pins and each pin 54 includes a male taper pin and a female taper pin. The pins 54 are actuated by the pneumatic cylinders 50. The pins 54 can be formed of any suitable material, such as a metal, and can have any suitable dimensions. For example, the pins 54 each have a diameter of approximately 0.1 to 2 inches, preferably 0.5 to 1.5 inches, and a height of approximately 1 to 5 inches, preferably 2 to 3 inches.

The first controller 45 is configured to control the lower portion 42 and upper portion 44 of the base in a locked state as shown in FIGS. 2a-2e. The first controller 45 is any suitable electronic controller configured to control the to selectively lock and unlock the upper and lower portions 44, 42 to prevent rotation of the upper portion 44 with respect to the lower portion 42. The first controller 45 is preferably a programmable logic controller.

The first controller 45 includes one or more processors that execute predetermined control programs to actuate the lock. In particular, the first controller 45 is configured to control the pneumatic cylinders 50 to hold the taper pins 54 in place in the locked state using air pressure when the robot 46 is in a state of normal operation. The pneumatic cylinders 50 are configured to hold the taper pins 54 in place by applying air pressure, for example with a pressure of 80 psi to 110 psi. By controlling the pneumatic cylinders 50 to hold the taper pins 54 in place during normal operation, the first controller 45 prevents rotation of the upper portion 44 in the locked state of FIGS. 2a-2d. The processors of the first controller 45 include, for example, a CPU or a MPU.

The processors of the first controller 45 can be located at separate positions. For example, some of the processors can be provided in the robotic system 40, and others can be provided in a remote server connected to the internet. In a case where the processors are located at separate positions, the processors are connected to one another via a wireless communication device in a manner allowing for communication. The first controller 45 can include one or more microcomputers. Thus, the term “electronic controller” as used herein refers to hardware that executes a software program, and does not include a human.

The first controller 45 is in communication with the base 42/44 via wired or wireless communication. For example, the first controller 45 can be located in or within a predetermined distance of the robotic system 40 and can include a communication unit in wired communication with the lower portion 42 or the pneumatic cylinders 50. The first controller 45 is configured to send commands to the lower portion 42 and/or the pneumatic cylinders 50 to control the pneumatic cylinders 50 to actuate or release the pins 54 and thereby allow rotation of the upper portion 44 with respect to the lower portion 42.

As shown in FIGS. 2a-2d, the upper portion 44 of the base includes a support assembly 56 and an upper stand 58. The support assembly 56 and the upper stand 58 can be formed of any suitable materials, such as metals or plastic materials, preferably a metal such as carbon steel.

The support assembly 56 and upper stand 58 can have any suitable dimensions. For example, the support assembly 56 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches. The upper stand 58 has a width of approximately 2 to 10 inches, preferably 5 to 6 inches, a depth of approximately 2 to 10 inches, preferably 5 to 6 inches, and a height of approximately 10 to 40 inches, preferably 15 to 20 inches.

The robot 46 is mounted to the upper portion 44 by a connector 60. The connector 60 is any suitable connector for mounting a robot to a stand. For example, the connector 60 can be a flange with mechanical fasteners. In particular, the robot 46 can include a mounting flange with through holes, and the upper portion 44 can have a mounting flange with threaded holes. In such a case, the robot 46 and upper portion 44 are held together with socket head cap screws and washers that insert in the through holes of the mounting flange of the robot 46 and thread into the mounting flange of the upper portion 44. Other types of mechanical fasteners, such as bolts, nuts and studs, are also suitable.

The robot 46 also includes a lower arm 62, an upper arm 64 and a short top arm 66. It should be understood that the robot 46 can include any suitable number of arms to allow for sufficient movement of the robot 46 for its desired purpose and functionality. The short top arm 66 of the robot 46 is configured to connect to a tool for picking up objects, such as a grip part. The robot 46 and arms 62, 64 and 66 can have any suitable dimensions. For example, the robot arms 62, 64 and 66 can each have a diameter of approximately 2 to 20 inches, preferably 3 to 5 inches. The robot 46 has an overall height of 5 to 100 inches, preferably 30 to 40 inches.

As shown in FIGS. 2a-2d, the robotic system 40 also includes a second controller 47 configured to control movement of the robot 46. The second controller 47 is any suitable electronic controller configured to control the robot 46 to selectively move one or more of the arms 62, 64 and 66 in any desired direction(s). The second controller 47 is preferably a programmable logic controller. The second controller 47 includes one or more processors that execute predetermined control programs to move the arms 62, 64 and/or 66. The processors of the second controller 47 include, for example, a CPU or a MPU.

The processors of the second controller 47 can be located at separate positions. For example, some of the processors can be provided in the robotic system 40, and the other processors can be provided in a remote server connected to the internet. In a case where the processors are located at separate positions, the processors are connected to one another via a wireless communication device to allow for communication. The second controller 47 can include one or more microcomputers. Thus, the term “electronic controller” as used herein refers to hardware that executes a software program, and does not include a human.

The second controller 47 is in communication with the robot 46 via wired or wireless communication. For example, the second controller 47 can be located in or within a predetermined distance of the factory where the assembly line is located and can include a communication unit in wired communication with the robot 46. The second controller 47 is configured to send commands to the robot 46 to control the movement of the robot 46 to perform desired tasks.

The robotic system 40 also includes a first sensor 68 and a second sensor 70. The first sensor 68 is in communication with the controller 47 for the robot 46. The first sensor 68 is any suitable sensor configured to detect whether the robot 46 has collided with an object. For example, the first sensor 68 can include at least one of a motion detector, a position sensor and a force/torque sensor.

The second sensor 70 is in communication with the controller 45 for the lower portion 42 and upper portion 44 of the base. The second sensor 70 is any suitable sensor configured to detect whether the upper portion 44 is in a locked position with respect to the lower portion 42. For example, the second sensor 70 can include at least one of a position sensor and a force/torque sensor.

As shown in FIGS. 2a-2d, when the robotic system 40 is in a locked state, the taper pins 54 are held in place by pressure from the pneumatic cylinders 50. By holding the taper pins 54 in place in this manner, the support assembly 56 of the upper portion 44 is locked in place with respect to the support assembly 52 of the lower portion 42 and, thus, the upper portion 44 is not free to rotate with respect to the lower portion 42.

When the first sensor 68 detects that the robot 46, or any one of the arms 62, 64 or 66 of the robot 46, has collided with an object, the second controller 47 receives a signal that the robot 46 has collided with an object, and the second controller 47 sends a signal to the first controller 45 indicating that a collision has been detected. The first controller 45 then controls the pneumatic cylinders 50 to drop the pins 54 in any suitable manner. For example, the first controller 45 can control the pneumatic cylinders 50 to release the air pressure or can control the pneumatic cylinders 50 using the solenoid valve 53 by toggling the air pressure to the opposite port of the pneumatic cylinder 50 via the solenoid valve 53, thereby forcing the pins 54 down using air pressure. The pneumatic cylinders 50 are preferably controlled using the solenoid valve 53, thereby causing the pins 54 to quickly drop, in less than one second, preferably 0.1 to 0.5 seconds, such that the support assembly 56 can freely rotate away from the support assembly 52. The upper portion 44 can then rotate away freely due to reaction forces from the collision. However, it should be understood that if the upper portion 44 does not freely rotate away, the first controller 45 can send a signal to the upper portion 44 to rotate away from the lower portion 42.

As such, once the pins 54 have been dropped or released, the upper portion 44 rotates away from the lower portion 42 in the unlocked state shown in FIG. 2e. By providing the robotic system 40 in which the upper portion 44 on which the robot 46 is mounted can quickly be rotated away from lower portion 42, the robot 46 can quickly exit the protective-stop mode even after collision with a large immovable object.

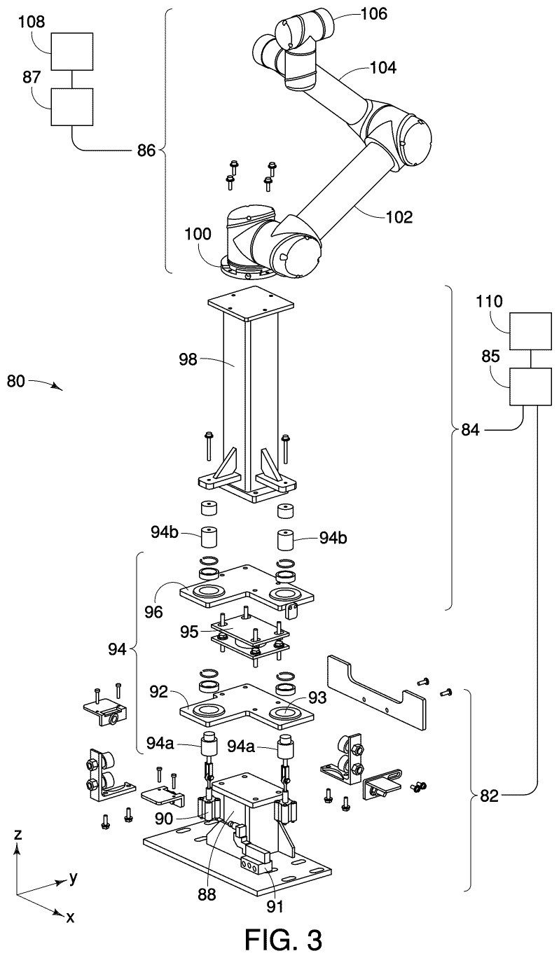

FIG. 3 shows an exploded perspective view of a robotic system 80 according to a third embodiment. As shown in FIG. 3, the robotic system 80 includes a base formed by a lower portion 82 and an upper portion 84, a first controller 85, a robot 86 mounted on the upper portion 84, and a second controller 87. The robot 86 can be mounted to the upper portion 84 in any suitable manner. For example, the robot 86 can be mounted to the upper portion 84 using at least one mechanical fastener such as a bolt, a nut, or a screw. The lower portion 82 is fixed to the ground or floor in any suitable manner. For example, the lower portion 82 can be fixed to the ground or floor using at least one mechanical fastener, such as a bolt, a nut, and/or a screw, an adhesive, or a combination thereof. The upper portion 84 is rotatable with respect to the lower portion 82 when it is not in a locked state.

As shown in FIG. 3, the lower portion 82 includes a lower stand 88, two pneumatic cylinders 90, a solenoid valve 91, and a support assembly 92 having two holes 93. The lower stand 88, the pneumatic cylinders 90, the solenoid valve 91 and the support assembly 92 can be formed of any suitable materials, such as metals or plastic materials, preferably a metal such as carbon steel.

The lower stand 88, pneumatic cylinders 90, solenoid valve 91, support assembly 92 and holes 93 can have any suitable dimensions. For example, the lower stand 88 has a width of approximately 2 to 10 inches, preferably 5 to 6 inches, a depth of approximately 2 to 10 inches, preferably 5 to 6 inches, and a height of approximately 3 to 15 inches, preferably 5 to 10 inches. The pneumatic cylinders 90 each have a diameter of approximately 0.1 to 2 inches, preferably 0.5 to 1.5 inches, and a height of approximately 1 to 5 inches, preferably 2 to 3 inches. The solenoid valve 91 has a width of approximately 0.5 to 5 inches, preferably 1 to 2 inches, a depth of approximately 0.1 to 2 inches, preferably 0.5 to 1.5 inches, and a height of approximately 1 to 5 inches, preferably 2 to 3 inches. The support assembly 92 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches.

The robotic system 80 includes two pins 94 that are configured to detachably lock the upper portion 84 of the base to prevent rotation with respect to the lower portion 82. The pins 94 are taper pins and each include a male taper pin 94a and a female taper pin 94b configured to mate with each other.

However, it should be understood that the pins can be any suitable pins that detachably lock the upper portion 84 of the base to prevent rotation, and can be released to allow the upper portion 84 to rotate with respect to the lower portion 82. The pins 94 are actuated by the pneumatic cylinders 90. The pins 94 can be formed of any suitable material, such as a metal, and can have any suitable dimensions. For example, the pins 94 each have a diameter of approximately 0.1 to 2 inches, preferably 0.5 to 1.5 inches, and a height of approximately 1 to 5 inches, preferably 2 to 3 inches.

The first controller 85 is configured to control the lower portion 82 and upper portion 84 of the base as shown in FIG. 3. The first controller 85 is any suitable electronic controller configured to control the to selectively lock and unlock the upper and lower portions 84, 82 to prevent rotation of the upper portion 84 with respect to the lower portion 82. The first controller 85 is preferably a programmable logic controller.

The first controller 85 includes one or more processors that execute predetermined control programs to actuate or release the lock. In particular, the first controller 85 is configured to control the pneumatic cylinders 90 to hold the taper pins 94 in place in a locked state using air pressure when the robot 86 is in a state of normal operation. The pneumatic cylinders 90 are configured to hold the taper pins 94 in place by applying air pressure, for example air having a pressure of 80 psi to 110 psi. By controlling the pneumatic cylinders 90 to hold the taper pins 94 in place during normal operation, the first controller 85 prevents rotation of the upper portion 84 in the locked state. The processors of the first controller 85 include, for example, a CPU or a MPU.

The processors of the first controller 85 can be located at separate positions. For example, some of the processors can be provided in the robotic system 80, and others can be provided in a remote server connected to the internet. In a case where the processors are located at separate positions, the processors are connected to one another via a wireless communication device in a manner allowing for communication. The first controller 85 can include one or more microcomputers. Thus, the term “electronic controller” as used herein refers to hardware that executes a software program, and does not include a human.

The first controller 85 is in communication with the base 82/84 via wired or wireless communication. For example, the first controller 85 can be located in or within a predetermined distance of the robotic system 80 and can include a communication unit in wired communication with the lower portion 82 or the pneumatic cylinders 90. The first controller 85 is configured to send commands to the lower portion 82 and/or the pneumatic cylinders 90 to control the pneumatic cylinders 90 to actuate or release the pins 94 and thereby allow rotation of the upper portion 84 with respect to the lower portion 82.

As shown in FIG. 3, the robotic system 80 includes a turntable 95 provided between the lower portion 82 and the upper portion 84. The turntable 95 allows the upper portion 84 to rotate with respect to the lower portion 82 when the robotic system 80 is in an unlocked state. The turntable 95 can be formed of any suitable materials, such as a metal.

The upper portion 84 of the base includes a support assembly 96 and an upper stand 98. The support assembly 96 and the upper stand 98 can be formed of any suitable materials, such as metals or plastic materials, preferably a metal such as carbon steel.

The support assembly 96 and upper stand 98 can have any suitable dimensions. For example, the support assembly 96 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches. The upper stand 98 has a width of approximately 2 to 10 inches, preferably 5 to 6 inches, a depth of approximately 2 to 10 inches, preferably 5 to 6 inches, and a height of approximately 10 to 40 inches, preferably 15 to 20 inches.

The robot 86 is mounted to the upper portion 84 by a connector 100. The connector 100 is any suitable connector for mounting a robot to a stand. For example, the connector 100 can be a flange with mechanical fasteners. In particular, the robot 86 can include a mounting flange with through holes, and the upper portion 84 can have a mounting flange with threaded holes. In such a case, the robot 86 and upper portion 84 are held together with socket head cap screws and washers that insert in the through holes of the mounting flange of the robot 86 and thread into the mounting flange of the upper portion 84. Other types of mechanical fasteners, such as bolts, nuts and studs, are also suitable.

The robot 86 also includes a lower arm 102, an upper arm 104 and a short top arm 106. It should be understood that the robot 86 can include any suitable number of arms to allow for sufficient movement of the robot 86 for its desired purpose and functionality. The short top arm 106 of the robot 86 is configured to connect to a tool for picking up objects, such as a grip part. The robot 86 and arms 102, 104 and 106 can have any suitable dimensions. For example, the robot arms 102, 104 and 106 can each have a diameter of approximately 2 to 20 inches, preferably 3 to 5 inches. The robot 46 has an overall height of 5 to 100 inches, preferably 30 to 40 inches.

As shown in FIG. 3, the robotic system 80 also includes a second controller 87 configured to control movement of the robot 86. The second controller 87 is any suitable electronic controller configured to control the robot 86 to selectively move one or more of the arms 102, 104 and 106 in any desired direction(s). The second controller 87 is preferably a programmable logic controller. The second controller 87 includes one or more processors that execute predetermined control programs to move the arms 102, 104 and/or 106. The processors of the second controller 87 include, for example, a CPU or a MPU.

The processors of the second controller 87 can be located at separate positions. For example, some of the processors can be provided in the robotic system 80, and the other processors can be provided in a remote server connected to the internet. In a case where the processors are located at separate positions, the processors are connected to one another via a wireless communication device to allow for communication. The second controller 87 can include one or more microcomputers. Thus, the term “electronic controller” as used herein refers to hardware that executes a software program, and does not include a human.

The second controller 87 is in communication with the robot 86 via wired or wireless communication. For example, the second controller 87 can be located in or within a predetermined distance of the factory where the assembly line is located and can include a communication unit in wired communication with the robot 86. The second controller 87 is configured to send commands to the robot 46 to control the movement of the robot 86 to perform desired tasks.

The robotic system 80 also includes a first sensor 108 and a second sensor 110. The first sensor 108 is in communication with the second controller 87 for the robot 86. The first sensor 108 is any suitable sensor configured to detect whether the robot 86 has collided with an object. For example, the first sensor 108 is a motion detector.

The second sensor 110 is in communication with the first controller 85 for the lower portion 82 and upper portion 84 of the base. The second sensor 110 is any suitable sensor configured to detect whether the upper portion 84 is in a locked position with respect to the lower portion 82. When the robotic system 80 is in a locked state, the taper pins 94 are held in place by the pneumatic cylinders 90 such that the upper portion 84 is not free to rotate with respect to the lower portion 82.

When the first sensor 108 detects that the robot 86, or any one of the arms 102, 104 or 106 of the robot 86, has collided with an object, the second controller 87 receives a signal that the robot 86 has collided with an object, and the second controller 87 sends a signal to the first controller 85 indicating that a collision has been detected. The first controller 85 then controls the pneumatic cylinders 90 to drop the pins 94 in any suitable manner. For example, the first controller 85 can control the pneumatic cylinders 90 using the solenoid valve 91 by toggling the air pressure to the opposite port of the pneumatic cylinder 90 via the solenoid valve 91, thereby forcing the male pins 94a down using air pressure. The male pins 94a are then quickly dropped, in less than one second, preferably 0.1 to 0.5 seconds, such that the support assembly 96 can freely rotate away from the support assembly 92. The upper portion 84 can then rotate away freely due to reaction forces from the collision. However, it should be understood that if the upper portion 84 does not freely rotate away, the first controller 85 can send a signal to the upper portion 84 to rotate away from the lower portion 82.

As such, once the pins 94 have been dropped or released, the upper portion 84 rotates away from the lower portion 82 in an unlocked state. By providing the robotic system 80 in which the upper portion 84 on which the robot 86 is mounted can quickly be rotated away from lower portion 82, the robot 86 can quickly exit the protective-stop mode and re-initialize normal operation even after collision with a large immovable object.

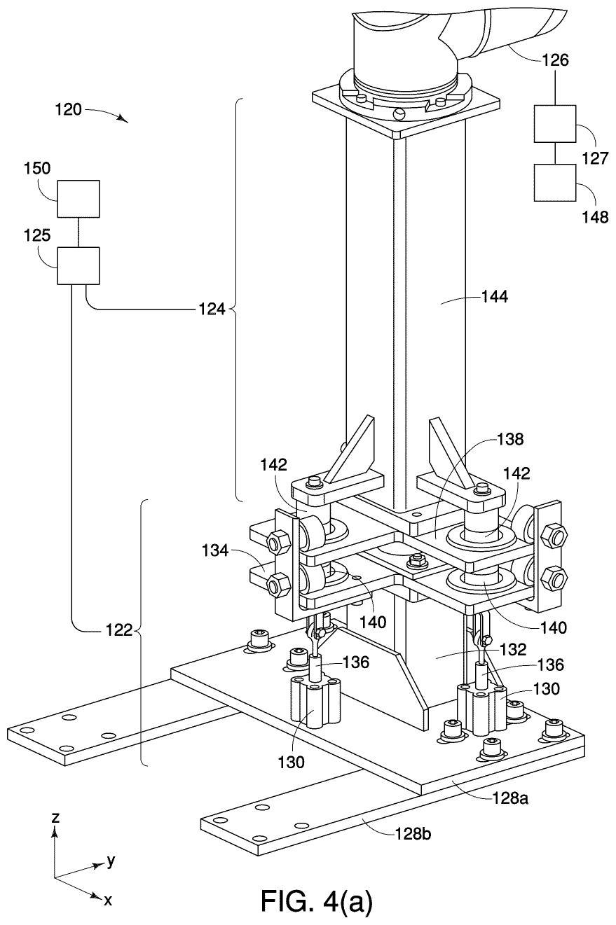

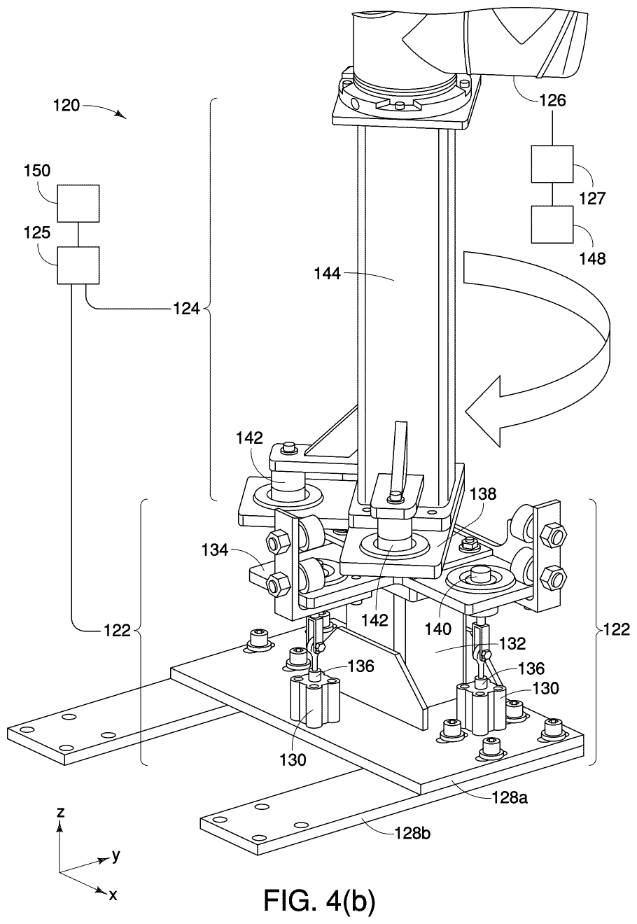

FIG. 4a shows a partial perspective view of a robotic system 120 in a locked state according to a fourth embodiment. As shown in FIG. 4a, the robotic system 120 includes a base formed by a lower portion 122 and an upper portion 124, a first controller 125, a robot 126 mounted on the upper portion 124, and a second controller 127. The robot 126 can be mounted to the upper portion 124 in any suitable manner. For example, the robot 126 can be mounted to the upper portion 124 using at least one mechanical fastener such as a bolt, a nut, and/or a screw. The lower portion 122 is fixed or anchored to the ground or floor in any suitable manner. For example, the lower portion 122 can be fixed to the ground or floor using at least one mechanical fastener, such as a bolt, a nut, and/or a screw, an adhesive, or a combination thereof. The upper portion 124 is rotatable with respect to the lower portion 122 when it is not in the locked state.

As shown in FIG. 4a, the lower portion 122 includes a first flat base 128a and a second flat base 128b provided below base 128a, two pneumatic cylinders 130, a lower stand 132, and a support assembly 134 for the lower portion 122. The first flat base 128a and second flat base 128b, the pneumatic cylinders 130, the lower stand 132 and the support assembly 134 can be formed of any suitable materials, such as metals or plastic materials, preferably a metal such as carbon steel.

The first flat base 128a and second flat base 128b, pneumatic cylinders 130, lower stand 132 and support assembly 134 can have any suitable dimensions. For example, the first flat base 128a has a width of approximately 5 to 20 inches, preferably 15 to 20 inches, a depth of approximately 5 to 20 inches, preferably 8 to 10 inches, and a height of approximately 0.05 to 3 inches, preferably 0.5 to 1.5 inches, and the second flat base 128b has a width of approximately 5 to 20 inches, preferably 15 to 20 inches, a depth of approximately 10 to 40 inches, preferably 16 to 20 inches, and a height of approximately 0.05 to 3 inches, preferably 0.5 to 1.5 inches. The pneumatic cylinders 130 each have a diameter of approximately 0.1 to 2 inches, preferably 0.5 to 1.5 inches, and a height of approximately 1 to 5 inches, preferably 2 to 3 inches. The lower stand 132 has a width of approximately 2 to 10 inches, preferably 5 to 7 inches, a depth of approximately 1 to 10 inches, preferably 3 to 6 inches, and a height of approximately 3 to 15 inches, preferably 5 to 10 inches. The support assembly 134 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches.

The robotic system 120 includes two rods 136, two male pins 140 and two female pins 142 that are configured to detachably lock the upper portion 124 of the base to prevent rotation with respect to the lower portion 122. The male pins 140 and female pins 142 are taper pins that are configured to mate with each other.

The pins 140, 142 in this embodiment are taper pins, but they can be any suitable pins that detachably lock the upper portion 124 of the base to prevent rotation with respect to the lower portion 122, and can be released to allow the upper portion 124 to rotate with respect to the lower portion 122. The male taper pins 140 are actuated by the pneumatic cylinders 130. The male taper pins 140 and the female taper pins 142 can be formed of any suitable material, such as a metal, and can have any suitable dimensions. For example, the taper pins 140, 142 each have a diameter of approximately 0.1 to 2 inches, preferably 0.5 to 1.5 inches, and a height of approximately 1 to 5 inches, preferably 2 to 3 inches. Although not shown, it should be understood that the male taper pin 140 has a smaller diameter at a top portion that is configured to fit inside the female taper pin 142.

The first controller 125 is configured to control the lower portion 122 and upper portion 124 of the base in a locked state as shown in FIG. 4a. The first controller 125 is any suitable electronic controller configured to selectively lock and unlock the upper and lower portions 124, 122 to prevent rotation of the upper portion 124 with respect to the lower portion 122. The first controller 125 is preferably a programmable logic controller.

The first controller 125 includes one or more processors that execute predetermined control programs to actuate or release the lock to selectively allow rotation of the upper portion 124 with respect to the lower portion 122. In particular, the first controller 125 is configured to control the pneumatic cylinders 130 to hold the male taper pins 136 and the female taper pins 140 in place in the locked state using air pressure when the robot 126 is in a state of normal operation. The pneumatic cylinders 130 are configured to hold the male taper pins 136 and the female taper pins 140 in place by applying air pressure, for example air having a pressure of 80 psi to 110 psi. By controlling the pneumatic cylinders 130 to hold the male taper pins 136 and the female taper pins 140 in place during normal operation, the first controller 125 prevents rotation of the upper portion 124 with respect to the lower portion 122 in the locked state of FIG. 4a. The processors of the first controller 125 include, for example, a CPU or a MPU.

The processors of the first controller 125 can be located at separate positions. For example, some of the processors can be provided in the robotic system 120, and other processors can be provided in a remote server connected to the internet. When the processors are located at separate positions, they are connected to one another via a wireless communication device to allow for communication. The first controller 125 can include one or more microcomputers. Thus, the term “electronic controller” as used herein refers to hardware that executes a software program, and does not include a human.

The first controller 125 is in communication with the base 122/124 via wired or wireless communication. For example, the first controller 125 can be located in or within a predetermined distance of the robotic system 120 and can include a communication unit in wired communication with the lower portion 122, the upper portion 124 and/or the pneumatic cylinders 130. The first controller 125 is configured to send commands to the portions 122/124 and/or the pneumatic cylinders 130 to control the pneumatic cylinders 130 to actuate or release the pins 136, 140 and thereby allow rotation of the upper portion 124 with respect to the lower portion 122.

As shown in FIG. 4a, the upper portion 124 of the base includes a support assembly 138 and an upper stand 144. The support assembly 138 and the upper stand 144 can be formed of any suitable materials, such as metals or plastic materials, preferably a metal such as carbon steel.

The support assembly 138 and upper stand 144 can have any suitable dimensions. For example, the support assembly 138 has an L-shape with a width of approximately 2 to 10 inches, preferably 5 to 7 inches, a depth of approximately 1 to 10 inches, preferably 3 to 6 inches, and a height of approximately 0.05 to 3 inches, preferably 0.5 to 1.5 inches. The upper stand 144 has a width of approximately 2 to 10 inches, preferably 5 to 6 inches, a depth of approximately 2 to 10 inches, preferably 5 to 6 inches, and a height of approximately 10 to 40 inches, preferably 15 to 20 inches.

As shown in FIG. 4a, the robotic system 120 also includes a second controller 127 configured to control movement of the robot 126. The second controller 127 is any suitable electronic controller configured to control the robot 126 to selectively move in any desired direction(s). The second controller 127 is preferably a programmable logic controller. The second controller 127 includes one or more processors that execute predetermined control programs to move the robot 126. The processors of the second controller 127 include, for example, a CPU or a MPU.

The processors of the second controller 127 can be located at separate positions. For example, some of the processors can be provided in the robotic system 120, and the other processors can be provided in a remote server connected to the internet. In a case where the processors are located at separate positions, the processors are connected to one another via a wireless communication device to allow for communication. The second controller 127 can include one or more microcomputers. Thus, the term “electronic controller” as used herein refers to hardware that executes a software program, and does not include a human.

The second controller 127 is in communication with the robot 126 via wired or wireless communication. For example, the second controller 127 can be located in or within a predetermined distance of the robotic system 120 and can include a communication unit in wired communication with the robot 126. The second controller 127 is configured to send commands to the robot 126 to control the movement of the robot 126 to perform desired tasks.

The robotic system 120 also includes a first sensor 148 and a second sensor 150. The first sensor 148 is in communication with the controller 127 for the robot 126. The first sensor 148 is any suitable sensor configured to detect whether the robot 126 has collided with an object. For example, the first sensor 148 is a motion detector.

The second sensor 150 is in communication with the first controller 125 for the lower portion 122 and upper portion 124 of the base. The second sensor 150 is any suitable sensor configured to detect whether the upper portion 124 is in a locked position with respect to the lower portion 122.

As shown in FIG. 4a, when the robotic system 120 is in a locked state, the male taper pins 140 and the female taper pins 142 are held in place by pressure from the pneumatic cylinders 130. By holding the male taper pins 140 and the female taper pins 142 in place in this manner, the support assembly 138 of the upper portion 124 is locked in place with respect to the support assembly 134 of the lower portion 122 and, thus, the upper portion 124 is not free to rotate with respect to the lower portion 122.

When the first sensor 148 detects that the robot 126 has collided with an object, the second controller 127 receives a signal that the robot 126 has collided with an object, and the second controller 127 sends a signal to the first controller 125 indicating that a collision has been detected. The first controller 125 then controls the pneumatic cylinders 130 to drop the male pins 140 in any suitable manner. For example, the first controller 125 can control the pneumatic cylinders 130 using a solenoid valve by toggling the air pressure to the opposite port of the pneumatic cylinder 130 via the solenoid valve, thereby forcing the male pins 140 down using air pressure. The male taper pins 140 are then quickly dropped in less than one second, preferably 0.1 to 0.5 seconds, such that the support assembly 138 can freely rotate away from the support assembly 134. The upper portion 124 can then rotate away freely due to reaction forces from the collision. However, it should be understood that if the upper portion 124 does not freely rotate away, the first controller 125 can send a signal to the upper portion 124 to rotate away from the lower portion 122.

As such, once the male taper pins 140 have been dropped or released, the rods 136 are pushed down into the pneumatic cylinders 130 and the upper portion 124 rotates away from the lower portion 122 in the unlocked state shown in FIG. 4b. By providing the robotic system 120 in which the upper portion 124 on which the robot 126 is mounted can quickly be rotated away from lower portion 122, the robot 126 can quickly exit the protective-stop mode even after collision with a large immovable object.

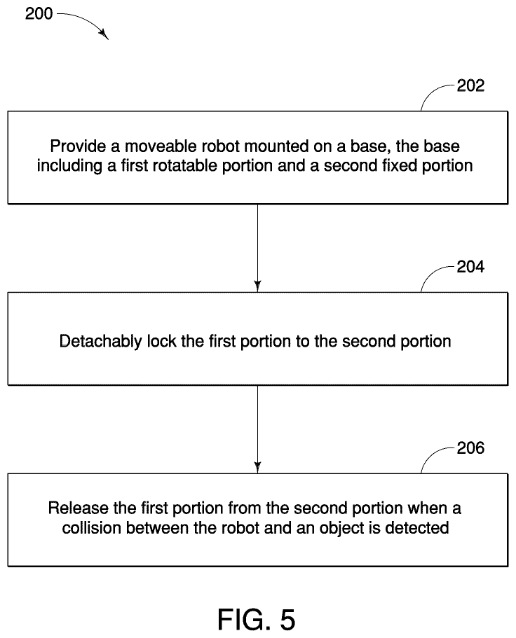

FIG. 5 shows a process 200 of controlling a robotic system according to a fifth embodiment. The robotic system is a cobot system in which a robot works alongside human workers. It should be understood that the robotic system can be used in an assembly line of any suitable factory or other production facility, such as a vehicle manufacturing facility.

In Step 202, the robotic system including a movable robot mounted on a base is provided. The base includes a first portion and a second portion. The first portion is an upper portion on which the base is mounted, and the second portion is a lower fixed portion. The robot can be mounted to the base in any suitable manner. For example, the robot can be mounted to the first portion of the base using at least one mechanical fastener such as a bolt, a nut, and/or a screw. The first portion is rotatable with respect to the second portion.

The base can be formed of any suitable materials. For example, the first portion and the second portion can each be formed of a metal or a plastic material, preferably a metal such as carbon steel. The base has any suitable dimensions. For example, the second portion has a width of approximately 5 to 20 inches, preferably 15 to 20 inches, a depth of approximately 5 to 20 inches, preferably 8 to 10 inches, and a height of approximately 3 to 15 inches, preferably 5 to 10 inches. The first portion has a width of approximately 2 to 10 inches, preferably 5 to 6 inches, a depth of approximately 15 to 20 inches, preferably 5 to 6 inches, and a height of approximately 10 to 40 inches, preferably 15 to 20 inches.

The robot includes a lower arm and an upper arm. It should be understood that the robot can include any suitable number of arms to allow for sufficient movement of the robot for its desired purpose and functionality. The robot also has a short top arm to allow for connection to a tool for picking up objects, such as a grip part. The robot and arms can have any suitable dimensions. For example, the robot arms can each have a diameter of approximately 2 to 20 inches, preferably 3 to 5 inches, and the robot can have an overall height of 5 to 100 inches, preferably 30 to 40 inches.

The base also includes at least one lock configured to detachably lock the first portion to prevent rotation with respect to the second portion. The lock can be any suitable lock that detachably locks the first portion of the base to prevent rotation with respect to the second portion, and can be released to allow the first portion to rotate with respect to the second portion. The lock is preferably a taper pin actuated by pneumatic cylinders.

The robotic system includes a first controller configured to control the base. The first controller is any suitable electronic controller configured to selectively allow and prevent rotation of the first portion with respect to the second portion. The first controller is preferably a programmable logic controller and includes one or more processors that execute predetermined control programs to actuate or release the lock to selectively allow rotation of the first portion with respect to the second portion.

The processors of the first controller include, for example, a CPU or a MPU. The processors of the first controller can be located at separate positions. For example, some of the processors can be provided in the robotic system, and the other processors can be provided in a remote server connected to the internet. In a case where the processors are located at separate positions, the processors are connected to one another via a wireless communication device in a manner allowing for communication. The first controller can include one or more microcomputers. Thus, the term “electronic controller” as used herein refers to hardware that executes a software program, and does not include a human.

The first controller is in communication with the base via wired or wireless communication. For example, the first controller can be located in or within a predetermined distance of the robotic system and can include a communication unit in wired communication with the base. The first controller is configured to send commands to the base to control the pneumatic cylinders to actuate or release the lock and thereby prevent or allow rotation of the first portion with respect to the second portion.

The robotic system further includes a second controller configured to control movement of the robot. The second controller is any suitable electronic controller configured to control the robot to selectively move one or more of the arms. The second controller is preferably a programmable logic controller. The second controller includes one or more processors that execute predetermined control programs to move one or more of the arms. The processors of the second controller include, for example, a CPU or a MPU.

The processors of the second controller can be located at separate positions. For example, some of the processors can be provided in the robotic system, and others can be provided in a remote server connected to the internet. In a case where the processors are located at separate positions, the processors are connected to one another via a wireless communication device in a manner allowing for communication. The second controller can include one or more microcomputers. Thus, the term “electronic controller” as used herein refers to hardware that executes a software program, and does not include a human.

The second controller is in communication with the robot via wired or wireless communication and is configured to send commands to the robot to control the movement of the robot to perform desired tasks. The second controller can be located in or within a predetermined distance of the robotic system and can include a communication unit in wired communication with the robot.

In Step 204, the first portion is detachably locked to the second portion of the base. In particular, the first controller is configured to control the pneumatic cylinders to hold the taper pins in place using air pressure when the robot is in a state of normal operation. The pneumatic cylinders are configured to hold the taper pins in place by applying air pressure, for example air having a pressure of 80 psi to 110 psi. By controlling the pneumatic cylinders to hold the taper pins in place during normal operation, the first controller prevents rotation of the first portion with respect to the second portion.

In Step 206, when the robotic system detects a collision between the robot and an object, the first controller is configured to control the pneumatic cylinders to drop the taper pins by releasing the air pressure, thereby allowing the first portion to rotate with respect to the second portion.

By providing the robotic system in which the first portion can be detachably locked to the second portion and released when a collision is detected, the robot mounted on the stand can be quickly rotated away from an object with which it has collided. Therefore, the robot can quickly recover to normal operation after the collision by quickly exiting the protective-stop mode and re-initializing operation. This allows for minimal downtime and disruption in operation.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

The term “width” as used herein refers to a length in the x direction, the term “depth” as used herein refers to a length in the y direction, and the term “height” as used herein refers to a length in the z direction.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A robotic system comprising:
a robot;
a controller configured to control movement of the robot;
a base on which the robot is mounted, the base comprising a first portion and a second portion; and
at least one lock,
the first portion being in contact with the robot and being rotatable with respect to the second portion,
the second portion being fixed, and
the at least one lock being configured to detachably lock the first portion of the base to prevent rotation with respect to the second portion.

2. The robotic system according to claim 1, wherein
the second portion of the base includes at least one pneumatic cylinder, each of the at least one pneumatic cylinder configured to actuate the at least one lock.

3. The robotic system according to claim 2, further comprising
a second controller configured to control each of the at least one pneumatic cylinder to hold the at least one lock in place.

4. The robotic system according to claim 3, wherein
the second controller is configured to control each of the at least one pneumatic cylinder to drop the at least one lock when a collision between the robot and an object is detected such that the first portion can rotate with respect to the second portion.

5. The robotic system according to claim 4, wherein
the controller is configured to stop the robot when a collision is detected and re-initialize the robot after the at least one lock is dropped.

6. The robotic system according to claim 1, further comprising a sensor configured to detect whether the robot has collided with an object.

7. The robotic system according to claim 1, wherein
the at least one lock is a taper pin.

8. The robotic system according to claim 1, wherein
the at least one lock includes a female pin disposed on the first portion and a male pin disposed on the second portion.

9. The robotic system according to claim 8, wherein
the male pin is configured to be dropped down to allow the first portion to rotate with respect to the second portion when a collision with an object is detected.

10. The robotic system according to claim 1, further comprising
a sensor configured to detect whether the first portion is in a locked position with respect to the second portion.

11. The robotic system according to claim 1, further comprising
a moving object,
wherein the controller is configured to control the robot to extend into the moving object.

12. The robotic system according to claim 1, wherein
the controller is configured to control each of the at least one pneumatic cylinder to drop the at least one lock when a collision with an object is detected such that the first portion can rotate with respect to the second portion.

13. The robotic system according to claim 12, wherein
the controller is a programmable logic controller.

14. A method for controlling a robotic system, the method comprising:
providing a movable robot and a base on which a robot is mounted, the base comprising a first portion and a second portion, the first portion being in contact with the robot and being rotatable with respect to the second portion;
detachably locking the first portion to the second portion; and
releasing the first portion from the second portion such that the first portion can rotate with respect to the second portion when a collision between the robot and an object is detected.

15. The method according to claim 14, further comprising
providing at least one lock to detachably lock the first portion to the second portion; and
actuating the at least one lock when the collision between the robot and the object is detected.

16. The method according to claim 15, wherein
the at least one lock is a taper pin.

17. The method according to claim 15, wherein
the at least one lock includes a female pin disposed on the first portion and a male pin disposed on the second portion.

18. The method according to claim 17, wherein
the releasing the first portion from the second portion comprises dropped the male pin down to allow the first portion to rotate with respect to the second portion.

19. The method according to claim 15, wherein
the base includes at least one pneumatic cylinder configured to actuate the at least one lock.

20. The method according to claim 14, further comprising
controlling the robot to stop when a collision is detected and re-initialize the robot after the first portion has been released from the second portion.
